(19) United States
(12) Patent Application Publication
(10) Pub. No.: US 2022/0127512 A1
(43) Pub. Date: Apr. 28, 2022

(54) POROUS AND PERMEABLE SPHERICAL SHAPED LCM FOR PAY ZONE LOSS CONTROL

(71) Applicant: SAUDI ARABIAN OIL COMPANY, Dhahran (SA)

(72) Inventors: Md Amanullah, Dhahran (SA); Raed Alouhali, Dhahran (SA); Mohammed Al-Arfaj, Dammam (SA)

(73) Assignee: SAUDI ARABIAN OIL COMPANY, Dhahran (SA)

(21) Appl. No.: 17/080,272

(22) Filed: Oct. 26, 2020

(51) Int. Cl. C09K 8/504; C09K 8/03; C09K 8/035; E21B 21/00

(52) U.S. Cl. CPC C09K 8/5045; E21B 21/003; C09K 8/035; C09K 8/032

(57) ABSTRACT

Lost circulation materials may include pluralities of ceramic spheres having a size distribution in a range of from about 5 mm to about 25 mm and such that the lost circulation materials are porous and permeable. Methods of eliminating or reducing lost circulation from a well having a loss zone may include introducing the porous and permeable lost circulation materials into the well such that a porous and permeable flow barrier is created in the loss zone, wherein the porous and permeable flow barrier may prevent whole mud loss while drilling and allows hydrocarbon production after completion of the well. Carrier fluids may include water, viscosifiers, fluid loss additives, weighting agents, lost circulation materials containing pluralities of ceramic spheres having a size distribution in a range of from about 5 mm to about 25 mm.

### BACKGROUND

Lost circulation is one of the frequent challenges encountered during drilling operations. As a wellbore is drilled, a drilling fluid is continuously pumped into the wellbore to clear and clean the wellbore and the filings. The drilling fluid is pumped from a mud pit into the wellbore and returns again to the surface. A lost circulation zone may be encountered and diagnosed when the flow rate of the drilling fluid that returns to the surface is less than the flow rate of the drilling fluid pumped into the wellbore. It is this reduction or absence of returning drilling fluid that is referred to as lost circulation.

While some fluid loss is expected, fluid loss beyond acceptable norms is not desirable from a technical, an economical, or an environmental point of view. About 75% of the wells drilled per year encounter lost circulation problems to some extent. Lost circulation is associated with problems with well control, borehole instability, pipe sticking, unsuccessful production tests, poor hydrocarbon production after well completion, and formation damage due to plugging of pores and pore throats by mud particles. In extreme cases, lost circulation problems may force abandonment of a well.

Lost circulation can be categorized as seepage type, moderate type, severe type, and total loss, referring to the amount of fluid or mud lost. The extent of the fluid loss and the ability to control the lost circulation with an LCM depends on the type of formation in which the lost circulation occurs. Formations with low permeability zones, that is, those with microscopic cracks and fissures, usually have seepage type lost circulation. Seepage type lost circulation experiences a loss of less than 25 bbl/hr (barrels per hour) for water based drilling muds, or about 10 bbl/hr for oil based drilling muds. Formations with narrow fracture sizes and lower fracture density usually trigger a moderate loss of drilling mud. A moderate type lost circulation experiences a loss at a rate in the range of about 10 bbl/hr to about 100 bbl/hr. Formations with high permeability zones, such as super-K formations, highly fractured formations with large fracture sizes and high fracture density, often experience high mud loss with a drastic increase in total mud and mud management costs. A severe type lost circulation experiences losses of greater than about 100 bbl/hr. Formations with inter-connected vugular and cavernous zones or formations with induced inter-vugular connection often cause massive loss of drilling mud with no return of circulation. It is possible for one wellbore to experience all of these zones.

In general, seepage type and moderate type losses occur more frequently than severe type lost circulation. In the Saudi Arabian fields, however, the formations encountered while drilling reservoir and non-reservoir sections have unique depositional histories and matrix characteristics that make the super-K, fractured, vugular, cavernous, faulted characteristics of the carbonate rock formations prone to moderate to massive loss of drilling fluid. Some of the losses are so massive that hundreds of barrels of mud are lost in an hour with no return of fluid to the mud return line. At that rate, the loss usually exceeds the rate of replacement of drilling mud. Thus, even though the frequency of severe lost circulation is less than seepage or moderate lost circulation, severe lost circulation has a significant safety and economic impact on drilling operations.

### SUMMARY

In one aspect, embodiments disclosed are directed to lost circulation materials including a plurality of ceramic spheres having a size distribution in a range of from about 5 mm to about 25 mm. The lost circulation materials may be porous and permeable.

In another aspect, embodiments disclosed are directed to methods of mitigating lost circulation from a well having a loss zone. The methods may include introducing lost circulation materials into the well such that porous and permeable flow barriers are created in the loss zone. In these methods, the lost circulation materials may contain a plurality of ceramic spheres having a size distribution in a range of from about 5 mm to about 25 mm. Further, the lost circulation materials may be configured to be both porous and permeable such that whole mud may be prevented from traversing the ceramic spheres into the loss zone but hydrocarbons may be permitted to traverse the ceramic spheres into the well.

In another aspect, embodiments disclosed are directed to a carrier fluids. Such a fluid may include water, one or more viscosifiers, one or more fluid loss additives, one or more weighting agents, and a lost circulation material. The lost circulation material may include a plurality of ceramic spheres having a size distribution in a range of from about 5 mm to about 25 mm.

Other aspects and advantages of this disclosure will be apparent from the following description made with reference to the accompanying drawings and the appended claims.

### BRIEF DESCRIPTION OF DRAWINGS

FIGS. 1A-1C show pictorial representations of flow barrier arrangements of the porous and permeable spherical shaped LCMs showing flow paths through the LCMs. FIG. 1A shows the flow paths through a flow barrier arrangement of a porous and permeable LCM ceramic spheres having a monomodal size distribution. FIG. 1B shows the flow paths through a flow barrier arrangement of a porous and permeable LCM ceramic spheres having a bimodal size distribution. FIG. 1C shows the flow paths through a flow barrier arrangement of a porous and permeable LCM ceramic spheres having a multimodal size distribution.

### DETAILED DESCRIPTION

Embodiments in accordance with the present disclosure generally relate to LCMs, their compositions, and related methods of mitigating lost circulation. One or more embodiments relate to LCMs, their compositions and related methods that can improve upon the prevention of moderate and severe loss circulation problems encountered in the presence of porous and permeable formations.

In particular, super-K zones describe porous and permeable reservoir formations having a greater flow capacity. However, these formations often trigger a severe loss of circulation and thus necessitate the sealing and blocking of lost circulation zones for safe and productive drilling operations. While many LCM products exist, these conventional LCMs are not suitable for reservoir applications because they completely seal and block the highly permeable super-K channels, which are also involved in the production of hydrocarbon.

Hence, there is a need for LCMs that can create a flow barrier in super-K channels to block the loss of whole mud in a well during drilling operations while also allowing the production of hydrocarbon after completion of the well.

One or more embodiments of the present disclosure relate to porous and permeable LCMs comprising ceramic spheres having size distributions of about 5 mm (millimeters) to about 25 mm that may be used as reservoir LCM to block the loss of whole mud in a well during drilling operations while allowing the production of hydrocarbon after the completion of the well.

One or more embodiments of the present disclosure relate to methods of eliminating or reducing lost circulation from a well using porous and permeable LCMs comprising ceramic spheres having size distributions in a range of from about 5 mm to about 25 mm that may provide porous and permeable flow barrier in the loss zone of the well. Such a configuration may prevent whole mud loss while drilling and allow hydrocarbon production after completion of the well. Such loss zones may be defined as those losing more than 100 barrels (bbls) per hour.

A “barrel” refers to a standard oilfield barrel having a volume of 42 U.S. gallons.

One or more embodiments of the present disclosure relate to carrier fluids including LCMs comprising ceramic spheres having size distributions in a range of from about 5 mm to about 25 mm as well as water, which may include freshwater, well water, filtered water, distilled water, sea water, salt water, produced water, formation brine, and additives, which may include viscosifiers, fluid loss additives, and weighting agents. These carrier fluids may be used in loss zones of wells to form porous and permeable flow barriers preventing or eliminating lost circulation in the loss zone.

In one or more embodiments of the present disclosure, the LCMs form flow barriers in loss zones of wells, the LCMs having pores and permeable channels smaller than the size of the smallest particles of mud systems present in the wells. The size of the smallest particles of drilling mud may range from about 5 microns to about 15 microns. The size of these smallest particles of mud systems may be measured using a laser particle size analyzer. Thus, the LCMs may have pores and permeable channels. The LCM may be configured such that the pore throats and channels have a width in a range of from about 0.1 microns to about 5 microns, such as from about 0.2 microns to about 4 microns, and such as from about 0.3 microns to about 3 microns, such as from about 0.4 microns to about 2 microns.

The mud systems or carrier fluid systems may include brine systems, salt water-polymer systems, and salt-free polymer systems. The mud systems coming from the wellbore may not be 100% clean. However, they may be adequately cleaned using mud circulation equipment, such as a settling tank, desander, desilter, mud cleaner, and centrifuge, to maintain the functionality of the muds at desirable levels. For example, the muds may be conditioned to have fluid loss less than 10 cc (cubic centimeters), plastic viscosity (PV) as low as possible, yield point (YP) of 15 to 30 lbs/100 ft² (pounds per square foot), and low shear yield point (LSYP) of greater than 7 lbs/100 ft².

The average pore size of reservoir rock in a conventional formation varies in a range of from about 2 to about 10 microns. However, due to the secondary porosity effect associated with the dissolution of rock minerals, such as carbonates, the pores and throat dimensions can be much greater. The porous and permeable LCMs comprise ceramic spheres having pore sizes from 2 to 5 microns to match the smallest particles present in the reservoir. The size range of these smallest particles is usually expressed as a D₁₀ value when measured using a laser particle size analyzer. However, the mud/carrier fluid will also have larger particles to seal and block pores of the reservoir rocks, which may have pore sizes greater than the typical average range. Accordingly, fine, medium and coarse particles of up to 600 microns in length of the longest dimension of the particle may be used to cover a wide range of pore and gap sizes. The fine, medium, and coarse particles may include calcium carbonate particles. The pore size distribution of reservoir rock can be determined using mercury injection capillary pressure method and the 3-D (3 dimensional) micro-computed tomography (CT) digital tomographic image of the reservoir rock. This information is used to base the pore size selection of the porous and permeable spheres.

In one or more embodiments of the present disclosure, the LCMs may form flow barriers in loss zones in reservoir formations. The LCMs have physical properties, such as porosity and permeability, similar to the physical properties of the reservoir formations. This similarity allows the LCMs to maintain similar flow behavior in the vicinity of the borehole of wells during oil production.

In one or more embodiments of the present disclosure, the LCMs form porous and permeable flow barriers enhancing near wellbore formation integrity and mechanical stability without compromising oil production.

The term “porous” refers to a material, such as an LCM, having a plurality of openings, pores, or holes. The term “permeable” refers to a material, such as an LEM, that may be filled by liquid or gaseous materials, such as treatment fluids, mud, or hydrocarbons. The term “porous and permeable” refers to a material, such as an LEM, in which the openings, pores, or holes, may be filled by liquid or gaseous materials, such as treatment fluids, mud, or hydrocarbons.

The term “size distribution” refers to the relative amount by volume of the LCMs present within a treatment fluid according to size. In some instances, the particles described may have a particle size distribution characterized by D₁₀, D₂₅, D₅₀, D₇₅, where the term “Dₙ” refers to a diameter (or size of the longest axis that runs through the LCMs) for which n % by volume of the LCMs have a smaller diameter. The size distribution of the LCM may be monomodal, bimodal, or multimodal. A multimodal size distribution may include trimodal or higher-order distributions, and random size distributions.

The term “ceramic” refers to the composition of the spherical material that comprises the LCMs of the present disclosure. The ceramic spheres may contain oxide, nitride, and carbide materials, such as inorganic, non-metallic, crystalline oxide, nitride, and carbide materials. In particular, the oxide, nitride, and carbide materials may include silicon, aluminum, and yttrium. The ceramic spheres may also include mixtures of one or more of an oxide, nitride, and carbide material with one or more polymers, including polymeric carbohydrates, such as starch, or resins, such as epoxy resin. For example, the ceramic spheres may include spheres of porcelain, clay, brick, and earthenware materials. The ceramic spheres may include indentations and physical characteristics that may further impart porous and permeable properties of the resulting LCMs. The ceramic spheres may be arranged to provide pores and channels of defined sizes through which only particles having sizes less than those of the pores and channels can pass through the arrangements of such ceramic spheres.

Lost Circulation Material

One or more embodiments provided may relate to a porous and permeable spherical shaped LCMs with enhanced loss control properties, where the LCMs include a plurality of ceramic spheres having size distributions of about 5 mm to about 25 mm. In some embodiments, the ceramic spheres of the porous and permeable spherical shaped LCMs may have size distributions of about 10 mm to about 25 mm. In some embodiments, the ceramic spheres of the porous and permeable spherical shaped LCMs may have size distributions of about 15 mm to about 25 mm. In some embodiments, the ceramic spheres of the porous and permeable spherical shaped LCMs may have size distributions of about 20 mm to about 25 mm. In some embodiments, the ceramic spheres of the porous and permeable spherical shaped LCMs may have size distributions of about 5 mm to about 20 mm. In some embodiments, the ceramic spheres of the porous and permeable spherical shaped LCMs may have size distributions of about 5 mm to about 15 mm. In some embodiments, the ceramic spheres of the porous and permeable spherical shaped LCMs may have size distributions of about 5 mm to about 10 mm. In some embodiments, the ceramic spheres of the porous and permeable spherical shaped LCMs may have size distributions of about 10 mm to about 20 mm. In some embodiments, the ceramic spheres of the porous and permeable spherical shaped LCMs may have size distributions of about 10 mm to about 15 mm. In some embodiments, the ceramic spheres of the porous and permeable spherical shaped LCMs may have size distributions of about 15 mm to about 20 mm.

In one or more embodiments, the ceramic spheres may have a size distribution, as determined by the diameters of the spheres that can pass or be retained through mesh openings, in a range of from about 5 mm to about 25 mm. Alternatively, the ceramic spheres may be described as ceramic spherical particles having a particle size distribution, as determined by the diameters of the ceramic spherical particles that can pass or be retained through mesh openings, in a range of from about 5 mm to about 25 mm.

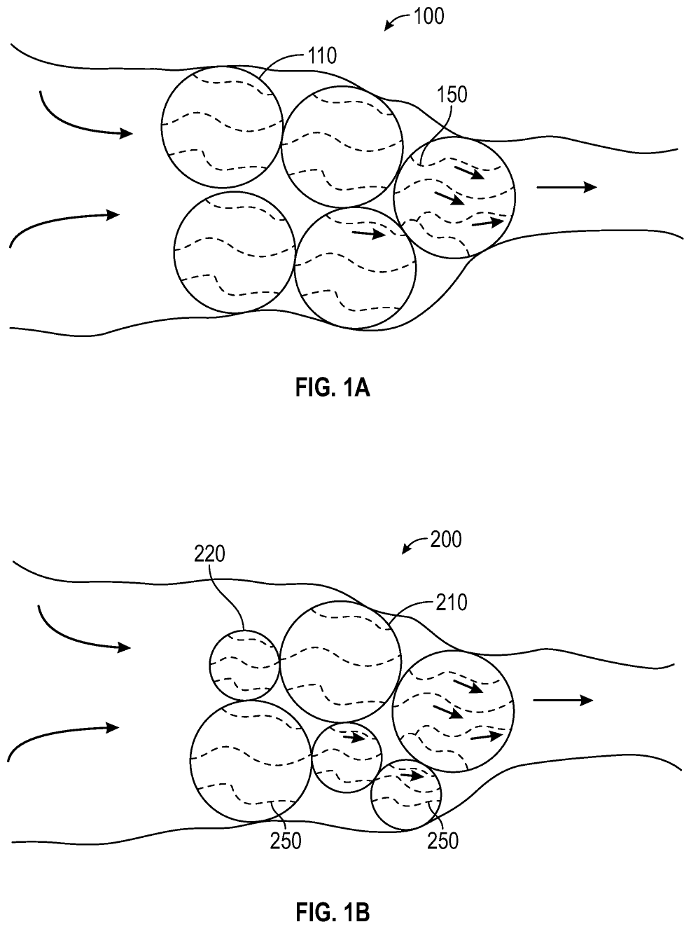

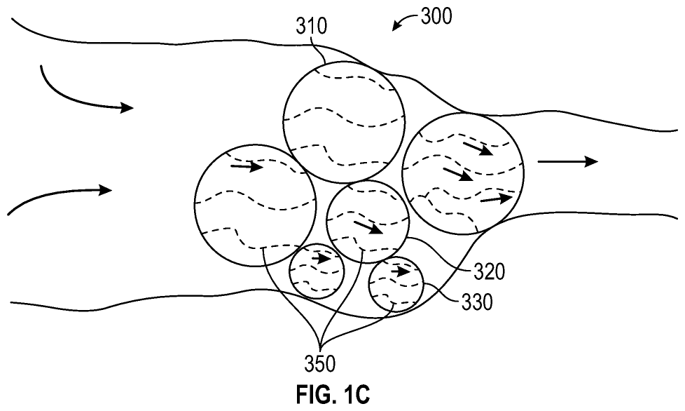

As illustrated in FIG. 1A, a porous and permeable spherical shaped LCM 100 of the present disclosure may have a monomodal size distribution of ceramic spheres 110, which provide flow paths 150 through the ceramic spheres 110. As illustrated in FIG. 1B, the porous and permeable spherical shaped LCM 200 of the present disclosure may have a bimodal size distribution of ceramic spheres 210 and 220, which provide flow paths 250 through the ceramic spheres 210 and 220. As illustrated in FIG. 1C, the porous and permeable spherical shaped LCM 300 of the present disclosure may have a multimodal size distribution of ceramic spheres 310, 320, and 330, which provide flow paths 350 through the ceramic spheres 310, 320, and 330. In one or more embodiments, the porous and permeable spherical shaped LCMs of the present disclosure may be specifically provided in size and size distribution of the ceramic spheres depending upon the ultimate properties of the environments in which they will be used.

In one or more embodiments, the ceramic spheres of the porous and permeable spherical shaped LCMs of the present disclosure may comprise inorganic, non-metallic, crystalline oxide, nitride, and carbide materials. In one or more embodiments, the ceramic spheres of the porous and permeable spherical shaped LCMs of the present disclosure may comprise porcelain, clay, brick, and earthenware. Additionally, the ceramic spheres of the porous and permeable spherical shaped LCMs described in the present disclosure may be chemically inert, physically granular, mechanically strong, environmentally-friendly and non-toxic.

As disclosed, in one or more embodiments, the ceramic spheres of the porous and permeable spherical shaped LCMs of the present disclosure may be manufactured by crushing, grinding, molding, sifting, drying, 3-D printing or any other processing that may be used to prepare ceramic spheres or spherical ceramic particles. Additionally, the ceramic spheres of the porous and permeable spherical shaped LCMs can be fabricated by using ceramic materials that can be reclaimed or recycled. For example, the ceramic spheres of the porous and permeable spherical shaped LCMs can be prepared from engineered mixtures of ball clay and starch, epoxy and ceramic particles, 20/40 mesh sand and starch, engineered cutting residues and epoxy or starch combination, partially sintered ball clay or 20/40 mesh sands or sized carbonate particles and starch or epoxy as a binder.

In one or more embodiments, the porous and permeable spherical shaped LCMs of the present disclosure are capable of forming porous and permeable flow barriers blocking fractures and channels in loss zones in wells under the action of wellbore differential pressure between the loss control zone and the wellbore and other in situ stresses experienced in a wellbore environment creating a flow. The LCM lodges into the vugs and fractures and get trapped there due to the differential pressure formed across the now wedged LCM. The flow barriers formed by the LCMs of the present disclosure are porous and permeable to allow hydrocarbons to flow through during oil production after completion of the wells.

In some embodiments, the LCMs may form a porous and permeable flow barrier comprising pores and channels when in contact with a loss zone in a mud system comprising particles. The pore throats and channels of the LCMs may have sizes smaller than about 5 microns, or smaller than about 4 microns, or smaller than about 3 microns, or smaller than about 2 microns. The range of smallest particles of the mud known as the D₁₀ value in laser particle size analyses. The average pore throats size of reservoir rock varies from about 2 to about 10 microns. However, due to the secondary porosity effect associated with the dissolution of rock minerals, such as carbonates, the pores and throat dimensions can be much greater. With the porous and permeable LCMs comprising ceramic spheres containing pore size ranging from 2 to 5 microns (to match the smallest particle size range), fine, medium and coarse particles of up to 600 microns may be used to cover a wide range of pore and gap sizes. The fine, medium, and coarse particles may include calcium carbonate particles. The pore size distribution of reservoir rock can be determined using mercury injection capillary pressure method and the 3-D micro-CT digital tomographic image of the reservoir rock. This information is used to base the pore size selection of the porous and permeable spheres. The drilling mud or carrier fluid allows the formation of a mudcake on the surface of the porous and permeable spheres similarly to the mudcake deposited on the porous and permeable reservoir rock. This mudcake present on the porous and permeable spheres prevents the infiltration of the fines into the porous and permeable matrix of the spheres and thus prevent their clogging. When production is expected, the producing hydrocarbon pressure creates a lift-off pressure to remove the mudcake, including the fines from the porous surface, and allow the production of hydrocarbon through the spheres. Accordingly, the porous and permeable LCMs remain porous and permeable. There is no need for removing any clogging material as the LCMs allow the production of hydrocarbon.

Carrier Fluids

The porous and permeable spherical shaped LCMs of the present disclosure may include a plurality of ceramic spheres of the same or different sizes that may be added to water-based fluids or drilling muds to create carrier fluids or drilling muds. The carrier fluids or drilling muds transport and place the porous and permeable spherical shaped LCMs into the loss zones to prevent or reduce lost circulation of whole mud.

The mitigation or prevention of lost circulation may occur through the formation of set seals or plugs that result from the porous and permeable spherical shaped LCMs becoming lodged into the fractures such that the spherical porous and permeable LCMs experience in situ stresses from the subterranean walls that define the fractures.

The porous and permeable spherical shaped LCMs also have a porosity and permeability configuration so that they may block the loss of whole mud during drilling and completions but allow the flow of hydrocarbons into the well during production.

The carrier fluids may be either “water-based” or “oil-based” depending on the constituency of their external continuous phase. The term “oil based” fluids designate fluids having a continuous phase based on synthetic or non-synthetic mineral oil. For example, the oil based fluids may include petroleum materials such as crude oils and distilled fractions of crude oils, including diesel oil, kerosene, and heavy petroleum refinery liquid residues. For a water-in-oil (W/O) emulsion, an aqueous, discontinuous phase is dispersed in the hydrocarbon phase. In some instances, the aqueous phase may be a brine. The opposite is true as there are also oil-in-water (O/W) emulsions.

The porous and permeable spherical shaped LCMs can be prepared by adding ceramic spheres of the same or different sizes to water-based or oil-based fluids or drilling muds. For example, ceramic spheres having a size distribution in a range of from about 5 mm to about 25 mm can be mixed together with water, viscosifiers, fluid loss additives, and weighting agents.

The porous and permeable spherical shaped LCMs may include a plurality of the same or different sizes of ceramic spheres that may be added to water-based or oil-based fluids or drilling muds to create carrier fluids or drilling muds. The carrier fluids or drilling muds transport and place the porous and permeable spherical shaped LCMs into the loss zones to prevent, eliminate or reduce the loss of whole mud.

In one or more embodiments, the carrier fluid may include porous and permeable spherical shaped LCMs in concentrations ranging from 1, 5, 6, 10, 20, 30, 40, and 50 ppb to 5, 6, 10, 20, 30, 35, 40, 45, 50, and 60 ppb (pounds per barrel), where any lower limit may be combined with any mathematically feasible upper limit. As will be appreciated, the specific selection of sizes and concentration of the porous and permeable spherical shaped LCMs may vary depending on the vugs, gaps, voids, fractures, and channels and sizes of the loss zone as well as the mechanism of introduction of the LCMs into the lost circulation zone. The size of the porous and permeable spherical shaped LCMs needed to seal the fractures may be ⅕ of the diameters of the fracture throats. The loss zone may include fractures, channels, vugs, gaps, and voids having throat sizes of about 5 to 125 mm. For bridging lost circulation zones having fractures, channels, vugs, gaps, and voids having throat diameters of about 5 to 25 mm, LCMs concentrations of about 1 to about 6 ppb may be used. For bridging lost circulation zones having fractures, channels, vugs, gaps, and voids having throat diameters of about 25 to 125 mm, LCMs concentrations of about 10 to about 60 ppb may be used.

In one or more embodiments of the present disclosure, the carrier fluid may include an aqueous carrier fluid. In one or more embodiments the carrier fluid may include one or more drilling fluid additives, such as wetting agents, organophilic clays, viscosifiers, surfactants, dispersants, interfacial tension reducers or emulsifying agents, rheological modifiers, pH buffers, mutual solvents, thinners, thinning agents, weighting agents, and cleaning agents. Carrier fluid additives may be added in amounts suitable to achieve the specific characteristics of the target fluid profile.

In one or more embodiments of the present disclosure, the porous and permeable spherical shaped LCMs may be capable of reducing fluid loss in a well formation at temperatures of less than 500° F. In one or more embodiments, a carrier fluid including the porous and permeable spherical shaped LCMs prepared in accordance with one or more embodiments of the present disclosure, can be introduced into the wellbore such that the carrier fluid contacts the lost circulation zone and results in the reduction of rate of lost circulation into the lost circulation zone. In one or more embodiments, the carrier fluid may be introduced into the wellbore such that the carrier fluid contacts the lost circulation zone and results in the mitigation of lost circulation.

In one or more embodiments, the porous and permeable spherical shaped LCMs may be added to a drilling fluid including aqueous based fluids, such as water based fluids, synthetic and natural salt water and brines, and any other aqueous based drilling fluid known to those skilled in the art. In one or more embodiments, the porous and permeable spherical shaped LCMs may be added to a drilling fluid including oil-based fluids, such as mineral oil-based fluids or synthetic oil-based fluids. The oil-based fluids may include a dispersed brine as non-continuous phase, and any other oil-based drilling fluid known to those skilled in the art. The oil-based fluids may include mineral oil, dearomatized mineral oil, or synthetic oils, including PAO (polyalpha olefins), LAO (linear alpha olefins), IO (internal olefins), isomerized ester based fluids (such as PETROFREE® (Baroid)) or highly refined, low toxicity oils, such as vegetable oils and vegetable esters, and processed waste vegetable oil.

An aqueous based fluid may be any suitable fluid, such as water, or a solution containing both water and one or more organic or inorganic compounds dissolved in the water or otherwise completely miscible with the water. The aqueous fluid in some embodiments may contain water, including freshwater, well water, filtered water, distilled water, seawater, salt water, produced water, formation brine, other type of water, or combinations of waters. In embodiments, the aqueous fluid may contain brine, including natural and synthetic brines. The aqueous fluid may include water containing water-soluble organic compounds, such as alcohols, organic acids, amines, aldehydes, ketones, esters, or other polar organic compounds, or salts dissolved in the water. In some embodiments, the aqueous fluid may include salts, water-soluble organic compounds, or both, as impurities dissolved in the water. Alternatively, in embodiments, the aqueous fluid may include salts, water-soluble organic compounds, or both, to modify at least one property of the aqueous fluid, such as density. In some embodiments, increasing the amount of salt, water-soluble organic compounds, or both, may increase the density of the carrier fluid. In some embodiments, salts that may be present in the aqueous fluid may include metal salts, such as sodium salts, calcium salts, cesium salts, zinc salts, aluminum salts, magnesium salts, potassium salts, strontium salts, silicates, lithium salts, or combinations of these, for example. The metal salts may be in the form of chlorides, bromides, carbonates, hydroxides, iodides, chlorates, bromates, formates, nitrates, sulfates, phosphates, aluminosilicates, oxides, fluorides, or combinations of these.

In some embodiments, the carrier fluid may also contain additives. One or more additives may be any additives known to be suitable for drilling fluids. For example, in one or more embodiments, the carrier fluid may comprise one or more additional additives, such as weighting agents, filler, fluid loss control agents, lost circulation control agents, defoamers, viscosifiers (or rheology modifiers), an alkali reserve, specialty additives, pH adjuster, alkalinity adjuster, shale inhibitors (including chemicals, salts and polymers that can be used to neutralize the negatively charged shale/clay particles to inhibit their interactions (swelling, disintegration and dispersion) with the water phase of drilling muds), wetting agents, softening agents, surfactants, thinning agents, dispersants, biocides, interfacial tension reducers, emulsifying agents and combinations thereof. One or more additives may be incorporated into the carrier fluid to enhance one or more characteristics of the carrier fluid.

In one or more embodiments, the carrier fluid may contain from about 0.01 wt % (weight percent) to about 30 wt % of the one or more additives based on the weight of the carrier fluid. In one or more embodiments, the carrier fluid may contain from 0.1, 0.5, 1.0, 1.5, 2.0, 2.5, 3.0, 4.0, 5.0, 6.0, 7.0, 8.0 10, 12, 14, and 16 wt % (weight percent) to 2.0, 2.5, 3.0, 3.5, 4.0, 5.0, 6.0, 7.0, 8.0, 10, 12, 14, 18, 20, 23, 25 and 30 wt % of the one or more additives based on the weight of the drilling fluid, where any lower limit may be combined with any mathematically feasible upper limit.

One or more viscosifiers may be incorporated into the carrier fluid to enhance one or more characteristics of the carrier fluid. For example, a viscosifier may be added to the carrier fluid to impart non-Newtonian fluid rheology to the drilling fluid to facilitate lifting and conveying rock cuttings to the surface of the wellbore. Examples of viscosifiers may include, but are not limited to, bentonite, montmorillonite clay, kaolin, (Al₂Si₂O₅(OH)₄ or kaolinite), polyacrylamide, polyanionic cellulose (PAC-R™ commercially available from M-I SWACO, Houston Tex.), carboxy methyl cellulose (CMC) and combinations of these. In some embodiments, the drilling fluid may include xanthan gum, a polysaccharide commonly referred to as XC polymer (commercially available from M-I SWACO, Houston Tex.), organic psyllium husk, guar gum, modified starch, clay, and combinations of these. The XC polymer may be added to the carrier fluid to produce a flat velocity profile of the drilling fluid in annular flow, which may help to improve the efficiency of the carrier fluid, in particular reduced density carrier fluids, in lifting and conveying rock cuttings to the surface.

One or more weighting agents may be incorporated into the carrier fluid. For example, the weighting agents may include various salts, including calcium carbonate, sodium carbonate, sodium chloride, calcium chloride, sodium bromide, calcium bromide, sodium formate, potassium formate, and cesium formate or a combination thereof. The weighting agents may further include oxides of metals, alkaline metals, and alkaline earth metals. In particular, the weighting agents may include calcium carbonate particles, the calcium carbonate particles may include sized calcium carbonate particles, such as fine (F) calcium carbonate particles (about 10 to 15 micron), medium (M) calcium carbonate particles (about 135 to 165 micron), and coarse (C) calcium carbonate particles (about 550 to 650 micron).

One or more fluid loss additives may be incorporated into the carrier fluid. For example, the fluid loss additives may comprise a wetting agent, a softening agent, a surfactant, a thinning agent, a dispersant, a pH modifier, an alkalinity adjuster, a biocide an interfacial tension reducer, and an emulsifying agent.

Embodiments of the carrier fluid composition may optionally include from about 0.01 wt % to about 7.0 wt % viscosifier based on the weight of the carrier fluid composition. In other embodiments, carrier fluid composition may optionally include from 0.01 wt % to 6.5 wt %, from 0.01 wt % to 5.0 wt %, from 0.01 wt % to 4.0 wt %, from 0.01 wt % to 3.0 wt %, from 0.05 wt % to 5.5 wt %, from 0.05 wt % to 4.0 wt %, from 0.05 wt % to 3.0 wt %, from 0.05 wt % to 2.0 wt %, from 0.1 wt % to 5.0 wt %, from 0.1 wt % to 4.5 wt %, from 0.1 wt % to 4.0 wt %, from 0.3 wt % to 4.0 wt %, from 0.3 wt % to 3.5 wt %, or from 0.5 wt % to 3.0 wt % viscosifier, based on the total weight of the carrier fluid composition. Unless otherwise stated, the weight percent of an additive in the carrier fluid composition is based on the weight of the drilling fluid composition.

Methods

One or more embodiments may include methods of preparing carrier fluids or drilling muds including LCMs to eliminate or reduce severe lost circulation while drilling through subsurface loss zones of wellbores. Methods of preparation of water-based carrier fluids or drilling muds may include combining LCMs comprising of a plurality of ceramic spheres with water, viscosifiers, fluid loss additives, weighting agents, and optionally one or more drilling fluid additives.

One or more embodiments may include methods of introducing the LCMs or carrier fluids into severe loss zones such that a plurality of ceramic spheres of the porous and permeable spherical shaped LCMs become lodged in at least one fracture that defines a severe loss zone. The LCMs may include ceramic spheres that are capable of arranging in flow barriers in lost zones. The flow barriers are porous and permeable and are able to prevent whole mud loss while drilling and allow hydrocarbon flow during production after completion of the well.

In one or more embodiments, the LCMs comprising the plurality of ceramic spheres may be added directly to an aqueous fluid to form a carrier fluid having the porous and permeable spherical shaped LCMs. For example, in some embodiments, the porous and permeable spherical shaped LCM may be added to (for example, blended with) a water-based drilling mud. In some embodiments, the porous and permeable spherical shaped LCM may be added at the mud pit of a mud system. In some embodiments, the porous and permeable spherical shaped LCM may be added to an aqueous fluid in an amount in the range of about 10 ppb to about 50 ppb. After addition of the porous and permeable spherical shaped LCM to an aqueous fluid, the resulting carrier fluid may be circulated at a pump rate effective to position the carrier fluid into contact with a lost circulation zone in a wellbore such that the porous and permeable spherical shaped LCM alters the lost circulation zone (for example, by entering and blocking porous and permeable paths, cracks, and fractures in a formation in the lost circulation zone, such as forming a structure (for example, a plug or seal) in a mouth or within a fracture). In one or more embodiments, the carrier fluid may be a water-based mud including one or more drilling fluid additives. In some embodiments, the porous and permeable spherical shaped LCMs may be introduced to the loss zone through a drill string disposed within the wellbore. In some embodiments, the porous and permeable spherical shaped LCMs may be introduced to the loss zone through coiled tubing disposed within the wellbore.

In one or more embodiments, the porous and permeable spherical shaped LCM may be added stepwise or simultaneously along with additional drilling fluid additives to an aqueous fluid, such as a drilling mud, to create a carrier fluid having the porous and permeable spherical shaped LCM.

In one or more embodiments, aqueous-based or oil-based carrier fluid compositions may be introduced into a wellbore such that the composition contacts the loss zone in the wellbore and creates a porous and permeable flow barriers that prevents the loss of whole mud but allowing the flow of mud filtrate (the liquid phase of the whole mud) only while drilling and also allowing the production of hydrocarbon after the completion of a well. In one or more embodiments, the filtrate loss may be less than 10 cc/30 min (cubic centimeters/30 minutes), or less than 7 cc/30 min, or less than 5 cc/30 min, or less than 1 cc/30 min.

### EXAMPLES

The following examples are merely illustrative and should not be interpreted as limiting the scope of the present disclosure.

### Example 1—Monovalent Salt-Based Aqueous Carrier Fluid

Example 1 is directed to an aqueous carrier fluid containing the LCMs comprising ceramic spheres having a size distribution of about 5 mm to about 25 mm. This carrier fluid contains a monovalent cation salt (alkali metal salt sodium chloride). The carrier fluid also contains alkaline additive NaOH to adjust the pH to a range of from about 9 to about 10. The carrier fluid further contains a plurality of particles including fine (F), medium (M), and coarse (C) grades of sized calcium carbonate CaCO₃ particles. Table 1 shows the composition of the first drilling brine, such as a monovalent salt-based aqueous carrier fluid.

TABLE 1

| Components | Amount |
|---|---|
| Water (cm³) | 292 |
| NaCl (g) | 75 |
| XC Polymer (g) | 1.5 |
| Modified starch¹ (g) | 6 |
| Biocide² (cm³) | 0.5 |
| NaOH (g) | 0.3 |
| CaCO₃, (F) (g) | 20 |
| CaCO₃, (M) (g) | 10 |
| CaCO₃, (C) (g) | 5 |
| Shale Inhibitor³ (g) | 4 |
| Porous and permeable spherical LCMs | 15 |
| (ppb) | |

¹Potato or corn starch modified using a crosslinking agent and then hydroxy-propylated or carboxymethylated to enhance the functional capability.
²Liquid product to prevent the bacterial degradation of starch and other organic products, such as glutaraldehyde, methylisothiazolinone, or hexahydrotriazine.
³Chemicals, salts and polymers that can be used to neutralize the negatively charged shale/clay particles to inhibit their interactions (swelling, disintegration and dispersion) with the water phase of drilling muds such as Performatrol (Halliburton Baroid). Poly-Plus and KLA-Stop (Schlumberger), Soltex (Chevron).

### Example 2—Divalent Salt-Based Aqueous Carrier Fluid

Example 2 is directed to an aqueous carrier fluid containing the LCMs comprising ceramic spheres having a size distribution of about 5 mm to about 25 mm. This carrier fluid contains a divalent cation salt (alkaline earth metal salt calcium dichloride). The carrier fluid further contains a plurality of particles including fine (F), medium (M), and coarse (C) grades of sized calcium carbonate CaCO₃ particles. Table 2 shows the composition of a second drilling brine, such as a divalent salt-based aqueous carrier fluid.

TABLE 2

| Components | Amount |
|---|---|
| Water (cm³) | 283 |
| CaCl₂ (g) | 100 |
| XC Polymer (g) | 1.5 |
| Modified starch⁴ (g) | 6 |
| Biocide⁵ (cm³) | 0.5 |
| NaOH (g) | 0.3 |
| CaCO₃, F (g) | 20 |
| CaCO₃, M (g) | 10 |
| CaCO₃, C (g) | 5 |
| Shale Inhibitor⁶ (g) | 4 |
| Porous and permeable spherical LCMs | 15 |
| (ppb) | |

⁴Potato or corn starch modified using a crosslinking agent and then hydroxy-propylated or carboxymethylated to enhance the functional capability.
⁵Liquid product to prevent the bacterial degradation of starch and other organic products such as glutaraldehyde, methylisothiazolinone, or hexahydrotriazine.
⁶Chemicals, salts and polymers that can be used to neutralize the negatively charged shale/clay particles to inhibit their interactions (swelling, disintegration and dispersion) with the water phase of drilling muds such as Performatrol (Halliburton Baroid), Poly-Plus and KLA-Stop (Schlumberger), Soltex (Chevron).

### Example 3—Mineral Oil-Based Non-Aqueous Carrier Fluid

Example 3 is directed to a non-aqueous carrier fluid containing the LCMs comprising ceramic spheres having a size distribution in a range of from about 5 mm to about 25 mm. This mineral oil-based non-aqueous carrier fluid is a mineral oil-based composition. The mineral oil-based non-aqueous carrier fluid contains a mineral oil as the base fluid, a primary and secondary emulsifiers to produce a tight water-in-oil emulsion, lime to adjust the alkalinity, a viscosifier to improve suspension and carrying capacity, a fluid loss additive to control mud filtrate loss (to be less than 10 cc/30 min), a dispersed brine as the non-continuous phase, and a plurality of particles including fine, medium, and coarse grades of sized calcium carbonate particles. Table 3 shows the composition of the invert emulsion having a mineral oil-based non-aqueous carrier fluid with a brine discontinuous phase.

TABLE 3

| Components | Amount |
|---|---|
| Base oil⁷ (cm³) | 186 |
| INVERMUL⁸ (cm³) | 10 |
| EZ-MUL⁹ (cm³) | 6 |
| Lime (g) | 5 |
| Viscosifier¹⁰ (g) | 6 |
| Fluid loss additive¹¹ (g) | 7 |
| Water (cm³) | 84 |
| CaCl₂ (g) | 61 |
| CaCO₃, F (g) | 25 |
| CaCO₃, M (g) | 20 |
| CaCO₃, C (g) | 15 |
| Porous and permeable spherical LCMs | 15 |
| (ppb) | |

⁷Mineral oil.
⁸Baroid, USA.
⁹Baroid, USA.
¹⁰Geltone—an organophilic clay, product of Baroid, USA.
¹¹Duratone—a modified lignite, product of Baroid, USA.

### Example 4—Synthetic Oil-Based Non-Aqueous Carrier Fluid

Example 4 is directed to a non-aqueous carrier fluid containing the LCMs comprising ceramic spheres having a size distribution of about 5 mm to about 25 mm. This carrier fluid is a synthetic oil-based composition. The mineral oil-based non-aqueous carrier fluid contains a synthetic oil as the base fluid, a primary and secondary emulsifiers to produce a tight water-in-oil emulsion, lime to adjust the alkalinity, a viscosifier to improve suspension and carrying capacity, a fluid loss additive to control mud filtrate loss (to be less than 10 cc/30 min), a dispersed brine as the non-continuous phase, and a plurality of particles including fine, medium, and coarse grades of sized calcium carbonate particles. Table 4 shows the composition of the invert emulsion having a synthetic oil-based (SOB) non-aqueous carrier fluid with a brine discontinuous phase.

TABLE 4

| Components | Amount |
|---|---|
| Base oil¹² (cm³) | 186 |
| INVERMUL¹³ (cm³) | 10 |
| EZ-MUL¹⁴ (cm³) | 6 |
| Lime (g) | 5 |
| Viscosifier¹⁵ (g) | 6 |
| Fluid loss additive¹⁶ (g) | 7 |
| Water (cm³) | 84 |
| CaCl₂ (g) | 61 |
| CaCO₃, F (g) | 65 |
| CaCO₃, M (g) | 65 |
| CaCO₃, C (g) | 65 |
| Porous and permeable spherical LCMs | 15 |
| (ppb) | |

¹²Highly refined low toxicity oil such as PAO (polyalpha olefins, Schlumberger, MI SWACO), LAO (linear alpha olefins, ExxonMobil), IO (internal olefins, Halliburton, ENCORE ®), petrofree (Halliburton Baroid) or other vegetable esters.
13Baroid, USA.
¹⁴Baroid, USA.
¹⁵Geltone—an organophilic clay, product of Baroid, USA.
¹⁶Duratone—a modified lignite, product of Baroid, USA.

### Example 5—Methods

The aqueous carrier fluid compositions of Examples 1 and 2 and the mineral and synthetic oil-based carrier fluid compositions of Examples 3 and 4 were introduced into a wellbore such that the composition contacted the loss zone to create a porous and permeable flow barrier preventing the loss of whole mud but allowing the flow of mud filtrate (the liquid phase of the whole mud). The filtrate loss was less than 10 cc/30 min. The methods followed the API (American Petroleum Institute) test using API filter press, 100 psi (pounds per square inch) pressure at room temperature, which is known to a person of ordinary skill in the art.

While only a limited number of embodiments have been described, those skilled in the art, having benefit of this disclosure, will appreciate that other embodiments can be devised which do not depart from the scope of the disclosure.

Although the preceding description has been described here with reference to particular means, materials and embodiments, it is not intended to be limited to the particulars disclosed here; rather, it extends to all functionally equivalent structures, methods and uses, such as those within the scope of the appended claims.

The presently disclosed methods and compositions may suitably comprise, consist or consist essentially of the elements disclosed and may be practiced in the absence of an element not disclosed. For example, those skilled in the art can recognize that certain steps can be combined into a single step.

Unless defined otherwise, all technical and scientific terms used have the same meaning as commonly understood by one of ordinary skill in the art to which these systems, apparatuses, methods, processes and compositions belong.

The ranges of this disclosure may be expressed in the disclosure as from about one particular value, to about another particular value, or both. When such a range is expressed, it is to be understood that another embodiment is from the one particular value, to the other particular value, or both, along with all combinations within this range.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

When the word “approximately” or “about” are used, this term may mean that there can be a variance in value of up to ±10%, of up to 5%, of up to 2%, of up to 1%, of up to 0.5%, of up to 0.1%, or up to 0.01%.

1. A lost circulation material comprising a plurality of ceramic spheres having a size distribution in a range of from about 5 mm to about 25 mm, wherein the lost circulation material is porous and permeable and wherein the ceramic spheres comprise one or more of an oxide, a nitride, or a carbide material.

2. The lost circulation material of claim 1, wherein the plurality of ceramic spheres has a size distribution selected from a group consisting of a monomodal size distribution, a bimodal size distribution, and a multimodal size distribution.

3. The lost circulation material of claim 1, wherein each ceramic sphere is configured to have a plurality of both pores with pore throats and channels, where the width of each pore throat and channel is less than about 5 microns.

4. A method of eliminating or reducing lost circulation from a well having a loss zone, the method comprising:
introducing a lost circulation material into the well such that a porous and permeable flow barrier is created in the loss zone,
wherein the lost circulation material comprises a plurality of ceramic spheres having a size distribution in a range of from about 5 mm to about 25 mm,
wherein the lost circulation material is porous and permeable.

5. The method of claim 4, wherein the introduced lost circulation material is in a concentration of about 1 to about 60 ppb in a carrier fluid.

6. The method of claim 4, further comprising introducing the lost circulation material to the loss zone through a drill string disposed within the wellbore.

7. The method of claim 4, further comprising introducing the lost circulation material to the loss zone through coiled tubing disposed within the wellbore.

8. The method of claim 4, wherein each ceramic sphere is configured to have a plurality of both pores with pore throats and channels, where the width of each pore throat and channel is less than about 5 microns.

9. The method of claim 4, wherein the plurality of ceramic spheres has a size distribution selected from a group consisting of a monomodal size distribution, a bimodal size distribution, and a multimodal size distribution.

10. A carrier fluid comprising:
water;
one or more viscosifiers;
one or more fluid loss additives;
one or more weighting agents; and
a lost circulation material comprising a plurality of ceramic spheres having a size distribution in a range of from about 5 mm to about 25 mm.

11. The carrier fluid of claim 10, wherein the water is selected from the group consisting of freshwater, well water, filtered water, distilled water, sea water, salt water, produced water, formation brine, other type of water, and combinations thereof.

12. The carrier fluid of claim 10 further comprising mineral oil or synthetic oil, and where the carrier fluid is an invert emulsion.

13. The carrier fluid of claim 10, wherein the one or more viscosifiers comprise bentonite, montmorillonite clay, kaolin, polyacrylamide, polyanionic cellulose, xanthan gum, carboxy methyl cellulose, organic psyllium husk, guar gum, and modified starch.

14. The carrier fluid of claim 10, wherein the one or more fluid loss additives comprise a wetting agent, a softening agent, a surfactant, a thinning agent, a dispersant, a pH modifier, an alkalinity adjuster, a biocide, an interfacial tension reducer, and an emulsifying agent.

15. The carrier fluid of claim 10, wherein the one or more weighting agents comprise sulfates, carbonates, silicates, phosphates, aluminosilicates, and oxides of metals, alkaline metals, and alkaline earth metals.

16. The carrier fluid of claim 10, wherein the plurality of ceramic spheres has a size distribution selected from a group consisting of a monomodal size distribution, a bimodal size distribution, and a multimodal size distribution.
